(19) United States
(12) Patent Application Publication
(10) Pub. No.: US 2014/0272061 A1
(43) Pub. Date: Sep. 18, 2014

(54) APPARATUS AND METHOD FOR CREATING A FOOD PRODUCT

(71) Applicant: Francis Shields, McLean, VA (US)

(72) Inventor: Francis Shields, McLean, VA (US)

(73) Assignee: MARS, INCORPORATED, McLean, VA (US)

(21) Appl. No.: 14/205,054

(22) Filed: Mar. 11, 2014

Related U.S. Application Data
(60) Provisional application No. 61/790,250, filed on Mar. 15, 2013.

(51) Int. Cl. A23P 1/12

(52) U.S. Cl. CPC A23P 1/12
USPC 426/516; 425/376.1

(57) ABSTRACT

The invention provides for an apparatus and method for producing food products without the use of an extruder. The apparatus generally comprises a conditioning element and a gear pump. The method generally comprises introducing a starch and/or protein material to the apparatus of the present invention. Advantageously, the apparatus uses less energy and avoids the back flow and scrap material often produced by the use of an extruder.

### CROSS-REFERENCE TO RELATED APPLICATION

This application claims priority under 35 U.S.C. 119(e) and 37 C.F.R. 1.78 based upon copending U.S. Provisional Application Ser. No. 61/790,250 for APPARATUS AND METHOD FOR CREATING A FOOD PRODUCT filed Mar. 15, 2013, the entirety of which is incorporated herein by reference.

The present invention is generally related to apparatus and methods for preparing a food product. The apparatus generally consists of a conditioning element and a gear pump, where the material flowing through and being processed in the apparatus undergoes a physical change. A method for preparing a food product is also provided for. The method of preparing the food product enhances the ease of production.

### BACKGROUND

Many food products produced today are prepared using extrusion technology. Extruders are generally comprised of one or more elongated barrels with one or more internal screws that move material or a stream of material through the barrel of the extruder. Extruders typically provide heat and pressure to the contents moving through the extruder in order to provide a cooked product. Extruders have several disadvantages such as the creation of backpressure in the system, high energy consumption, the creation of a lot of waste product, degradation of some ingredients, limitations on the type of product being produced, having to produce large runs of one product at a time, and subjecting products to shear. What is needed in the art is a way to produce products similar to those produced by an extruder without the use of an extruder.

### SUMMARY OF INVENTION

The present invention overcomes the problems present in the prior art and provides for an apparatus that comprises a conditioning mechanism and a gear pump. Advantageously, the apparatus of the present invention provides for an efficient way to process food products without the use of an extruder, wherein the resultant processed food is similar to an extruded product having a similar set of starting materials. A method for processing food products is also provided herein. The method generally comprises the steps of obtaining a food product or mixture of food products, introducing the food product to a conditioning element, processing, mixing, and/or conditioning the food product therein, and introducing the resulting material to a gear pump. The method preferably further comprises the step of introducing the food material to a die head after it exits the gear pump.

In one aspect of the present disclosure, the apparatus generally comprises a conditioner or conditioning element operably attached to a gear pump. The conditioning element can be any container for holding material that has the capacity to expose the material to both moisture and heat. The moisture and heat is preferably selected from steam, non-steam gas heat, and the combination of heat and liquid, where the liquid is preferably water. Preferably, any conditioner, pre-conditioner, or steam-producing cylinder known in the art for handling food products can be used for purposes of the present invention. The gear pump can be any gear pump that is capable of transporting flowable material from the conditioner. Typically, gear pumps consist of a rotating assembly of two gears (a drive gear and an idler gear) that moves to create suction at the inlet and draw in fluid.

In another aspect of the present disclosure, the apparatus additionally includes a transfer device operably linked to the gear pump at one end and the conditioner at the other end. The suction at the inlet of the gear pump can sometimes be lacking, therefore, preferably, the transfer device operates between the conditioning element and the gear pump and preferably works to force the material out of the conditioning element and into the gear pump. The transfer device preferable has variable speed capability. In a further embodiment steam is injected into the transfer device or external heating is utilized. One transfer device that would work with the apparatus of the present invention is that described in U.S. Pat. No. 8,177,414, the entirety of which is incorporated herein by reference.

Heat sensitive ingredients may be added prior to introduction of the material into the gear pump.

In a method aspect of the present disclosure, a method for processing food materials is provided. The method generally comprises the following steps: introducing a food product to a conditioning element, processing the food materials therein, and introducing the resulting material to a gear pump. Preferably, the method further comprises the step of introducing the processed food material to a die head. In an alternate embodiment, the method comprises the step of introducing the food product processed in the conditioner to a transfer device prior to the introduction of the food product to the gear pump.

The method of the present invention preferably results in a physical change in the food product. The physical change is preferably selected from, but not limited to protein denaturation and starch gelatinization.

The starting material for use with the method of the present invention can be any material or mixture of materials suitable for food consumption, such as, but not limited to, starches, fats, grains, vitamins, supplements, probiotics, pharmaceuticals, vaccines, oral care products, nutraceuticals, colorants, flavorants, liquids, meat compositions, and combinations thereof.

Because gear pumps operate more efficiently than extruders, costs relating to power consumption can be reduced for products made in accordance with the present disclosure. Additionally, gear pumps are much easier to clean and maintain than extruders, thereby resulting in additional cost benefits.

Products that can be made using the apparatus and method of the present invention are preferably treats, food, and chews for animals, such as raw hide products, bones, treats, chews, food products, and dual-texture products. These products can be easily and efficiently created utilizing the apparatus and method of the present invention. Advantageously, these products resemble similar extruded products (i.e. extruded products made with the same formulations used in the present disclosure) in their texture, shape, stability, nutritional content, and appearance. In the case of nutritional content, because the food material is not subjected to at least one of the heat, pressure, and shear experienced in conventional extrusion processes, products made using methods of the present disclosure may have an even higher nutritional content, especially of heat sensitive ingredients or ingredients that tend to degrade under extrusion conditions, than extruded products having similar formulations.

### DESCRIPTION OF FIGURES

FIG. 1 is a schematic representation of one embodiment of the apparatus of the present invention.

### DETAILED DESCRIPTION

The apparatus of the present invention preferably comprises a conditioner or conditioning element and a gear pump. In a preferred embodiment, the apparatus further comprises a die at the outlet of the gear pump. In an alternate embodiment, a transfer device is disposed at the outlet of the conditioner and the inlet of the gear pump. Advantageously, the apparatus of the present invention creates suitable cooked products without the use of an extruder.

The conditioning element is any element that provides a container for holding material and means for exposing that material to moisture and heat and having a material inlet and outlet. In some instances in the art, conditioning elements are referred to as preconditioners, often used in connection with an extruder. Preconditioners are customarily utilized for processing animal and food materials such as grains, corn, oats, wheat, meat, by-products of meat, and other additive materials. The heat source can be selected from, but is not limited to, steam, non-steam gas, direct heat, indirect heat, thermal heat, and combinations thereof. The moisture source is preferably water, but is not limited to that embodiment. Preferably, any conditioner, pre-conditioner, or steam-producing cylinder known in the art for handling food products can be used for purposes of the present invention. The conditioner can be a single barrel conditioner or a multiple barrel conditioner. The conditioner can be a high intensity conditioner or a low intensity conditioner. The conditioner may have one or more stages where the material introduced in the conditioner has a different set of conditions for each stage. A non-limiting example is where one stage may subject the material to high temperatures, while a second stage may introduce high intensity mixing conditions.

In one embodiment, the conditioning element of the present invention preferably has a drive or a motor that allows for agitation of the contents. The conditioner preferably comprises one or more elongated shafts. These elongated shafts can be stationery or rotatable shafts. In a preferred embodiment, the elongated shafts are rotatable and provide for agitation of the contents. Preferably, the shafts can include paddles, blades, protrusions, other mixing elements, and combinations thereof, but is not limited to these options. The one or more rotating shafts preferably rotate at speeds from 200 rpm-1000 rpm.

The gear pump is preferably any gear pump capable of displacing a flowable material. Preferably, the gear pump comprises a gear housing defining a passage having an inlet and an outlet. While a rotary type gear pump is preferred, other types of gear pumps will work for purposes of the present invention. The gear pump preferably comprises a material inlet and outlet. Optionally, the gear pump has one or more pressure relief valves. Preferably, the gear pump is one suited for use with food materials. The flow in the gear pump can be determined by the size of the cavity between the gear teeth, the speed of rotation of the gears and the amount of reverse flow. The amount of pressure placed on the contents in the gear pump can be determined by the rate of flow of the material through the gear pump and can be adjusted according to methods known to one of skill in the art.

The gear pump may be selected from, but is not limited to an external gear pump or an internal gear pump. The internal or external gear pump is preferably selected from, but not limited to, a rotary gear pump or a positive displacement gear pump. In a most preferred embodiment, the gear pump is an internal rotary gear pump. The gear pump may have any conventional gear mechanism. Spur gears or herringbone gears, are particularly preferred. Preferably, the wheels or gears of the pump are configured and dimensioned to avoid shearing the mixture as the gears rotate. The gear pump may be sized larger or smaller depending upon the type of product being introduced into the gear pump and the desired pressure. Further, the distance between the gears is preferably continuously adjustable, allowing the distance of one gear to be modulated farther from the distance of another gear.

In a preferred embodiment, the present invention further comprises a die at the outlet of the gear pump. The die can be any die known in the art for processing food products. Preferably, the die has at least one outlet, but can have one, two, three, four, five or more outlets, opening, or conduits. The die is preferably capable of making a variety of different products and different shapes. The shape, number, and spatial orientation of the outlets, openings, or conduits on the die will determine the size and shape of the product exiting the die. The types of products and shapes are preferably selected from, but not limited to, ropes, twisted ropes, pillow shapes, stars, hearts, squares, rectangles, circles, flowers, bones, hollow products, dual texture products, dual flavor products, shapes similar to those achievable by co-extruded products, treats, chews, nuggets, and combinations thereof. In the apparatus of the present invention, the die is preferably positioned in order to provide the appropriate amount of pressure on the materials being forced through the die while limiting the amount of shear. In one embodiment, the die may include a cutting device, portioning device, or combinations thereof. Further, more than one die, cutting device, or portioning device may be attached to the outlet of the gear pump.

Several possible orientations are envisioned for the apparatus of the present invention. The placement of the conditioning element and gear pump is preferably oriented such that the material exiting the conditioning element flows easily into the gear pump. This orientation is preferably to overcome the issue of decreased suction at the inlet of the gear pump. Preferably, the placement is such that the material flows from the conditioning element into the gear pump without the introduction of air or other gas that would cause a break in the flow of material. An angled orientation with the gear pump being lower than the conditioning element is especially preferred. Preferably, the apparatus is oriented at an angle of from about 10° to 90°, more preferably from about 20° to 90°, more preferably from about 30° to 90°, and most preferably from about 40° to 90°.

In an optional embodiment, the apparatus of the present invention also comprises a transfer device for facilitating the material from the conditioning element to the gear pump. The transfer device is preferably connected to the outlet of the conditioning element and the inlet of the gear pump. The transfer device may be anything in the art that is capable of aiding in the transfer of material from a conditioning element to a gear pump. Preferably, the transfer device is selected from, but not limited to, a hopper, a feeder screw assembly, a screw auger, or other device capable of transferring material. The transfer device preferably does not provide a source of heat or moisture. The transfer device preferably is designed to closely mate the outlet of the conditioning element and the inlet of the gear pump, such that it feeds the material from the outlet of the conditioning element to the inlet of the gear pump. Preferably, the transfer device reduces the potential for atmospheric contamination of the material being processed. The transfer device may comprise, but is not limited to, a screw, blades, paddles, or other type of mechanism for forcing material through the housing of the transfer element.

The apparatus of the present invention may also comprise elements known in the art for producing a food product, such as, but not limited to, cutting elements after the die, injection molds, and other product shaping equipment.

In one embodiment, a mechanism is added to the apparatus of the present invention that allows some or all of the material exiting the die to be re-fed to the inlet of the conditioning element. Preferably, the mechanism is a feedback loop that provides a means for modulating the amount of material looping back and the speed at which the material travels from the outlet of the die to the inlet of the conditioning element. It is preferred that the mechanism for providing the feedback loop has the capacity to continuously monitor the temperature and pressure of the material traveling from the outlet of the die to the inlet of the conditioning element. The mechanism may also be any device capable of positive displacement.

One preferred method of the present invention comprises the following steps: introducing a food product or a mixture of ingredients to a conditioning element, conditioning or processing the food product or mixture of ingredients, and introducing the resulting material to a gear pump. Preferably, the method further comprises the step of introducing the material to a die head. In an alternate embodiment, the method comprises the step of introducing the food product resulting from the conditioner to a transfer device prior to the introduction of the meat product to the gear pump. This step is not required. Conditioning or processing may include mixing the food product or ingredients, heating the food product or ingredients, modulating the moisture content of the mixture, and fluidizing the food product or ingredients such that they become flowable. Advantageously, the method of the present invention does not require the use of an extruder. Thus, the apparatus and method of the present invention provides an easier, more efficient and cost-effective way of producing products normally resulting from the use of an extruder. Further, the method overcomes the disadvantages of utilizing an extruder, such as a buildup of back pressure, swell, product limitations, energy consumption, cleaning and maintenance issues, and high amounts of product waste.

The method of the present invention preferably results in a physical change in the food product. The physical change is preferably selected from, but is not limited to, inactivation of raw food enzymes, destruction of certain naturally occurring toxins, reduction of microorganisms, increase of the bio-availability of certain chemical elements, creation of insulin-desensitizing starches, simplification of complex starches, heating the product, cooking the product, changing the chemical makeup, changing the melting point, altering the internal protein structure, changing the texture of the meat product, and combinations thereof.

In a preferred embodiment, the physical change of the food material is selected from, but not limited to gelatinization of a starch material, denaturation of protein material, and combinations thereof. The physical change of food material is preferably quantified by measuring gelatinization of any starch material. The starch material is preferably gelatinized from about 40% to 100%, more preferably from about 50% to 100%, even more preferably from about 60% to 100%, even more preferably from about 70% to 100%, more preferably from about 80% to 100%, and most preferably from about 90% to 100%. The physical change of the food material can also be measured by the protein denaturation. Preferably, from about 30% to 100% of the protein material denatures, more preferably from about 50% to 100%, and most preferably from about 70% to 100%. Preferably, the overall cook level of the product, as measured by gelatinization and/or denaturation, depending on the food material, ranges from about 30% to 100%, more preferably from about 40% to 100%, still more preferably from about 50% to 100%, more preferably from about 60% to 100%, most preferably from about 70% to 100%, and preferably from about 80% to 100%. In one embodiment, the food material is cooked to a cook level from about 70-85% after being introduced into the apparatus of the present invention.

Preferably, the apparatus and method of the present invention subject the food material to a little to no shear. The amount of shear the food materials are subjected to is preferably less than 50%, more preferably less than 40%, more preferably less than 30%, still more preferably less than 20%, and most preferably less than 15%.

The food material used for purpose of the method of the present invention can be any food material suitable for cooking using heat, moisture, and pressure. The food material is preferably selected from, but not limited to, grains, wheat, oat, corn, vegetables, starch materials, carbohydrates, fats, meat products, meat by-products, and combinations thereof. Meat products are preferably selected from, but not limited to, meat or hides from cows, pigs, mutton, fowl, poultry, fish, goats, horses, lamb, sheep, deer, rabbit, and combinations thereof. Any part of the animal may be utilized for purposes of the present invention. The meat or hide may be utilized alone for purposes of the present invention. Preferably, the meat or hide is combined with one more of the following: fats, starch, carbohydrates, sugar, flavorings, grains, vegetables, and combinations thereof. The food material may also be one that does not include any meat product or meat by-product. Additional ingredients can be added to the food product before, during or after the conditioning process. For example, vitamins, supplements, probiotics, pharmaceuticals, vaccines, oral care ingredients, nutraceuticals, colorants, flavorants, liquids, and the like can be included. Due to the absence of extrusion-induced conditions, some of these ingredients may survive the conditioning process better than if they were extruded. Thus, the present invention may permit lower amounts of these ingredients to be included in the initial formulation or mixture, but still result in desirable amounts in the final product.

In a preferred embodiment, the resulting food product is preferably a treat, food, or chew for a companion animal, however, the apparatus and methods of the present invention are not limited to this embodiment. The resulting food product could be a cereal, candy product, meat product, grain product, pastry product, pasta product, and combinations thereof.

FIG. 1 provides a non-limiting embodiment of the present invention. As shown in FIG. 1, the conditioning element 1 has an inlet hopper 15 where the food material is introduced. The conditioning element 1 also houses in a barrel 14 a mixing blade 13. The food material exits the conditioning element 1 and enters the gear pump 3, which houses a set of rotatable gears 9. After the food material pushes through the gear pump 3 it exits the pump and enters the die 4. The die 4 has cylindrical conduits 10 and optionally, a rotating knife 11, driven by a motor 12. A motor 5 drives the mixing blade 13.

### Example 1

### Materials and Methods

A conditioning element comprising a hopper with a mechanism for introducing moisture and heat will be connected to an internal rotary-type gear pump. The outlet of the conditioning element will be mated with the inlet of the gear pump. A die head comprising at least one cylindrical opening will be attached to the outlet of the gear pump. The apparatus will be oriented at a 35° angle to allow for the material in the conditioning element to flow into the gear pump without any breaks or exposure to the atmosphere.

### Results and Conclusions

The apparatus of the present invention will produce treats, chews, and food suitable for animals with similar physical characteristics including texture to those produced by an extruder.

### Example 2

### Materials and Methods

A mixture of poultry and rice will be introduced into the apparatus of Example 1, where a transfer device is connected to the outlet of the conditioning element and the inlet of the gear pump. The apparatus will not be placed at an angle. The apparatus will be allowed to operate in its normal capacity.

### Results and Conclusions

The method will produce a dog food that has about 90% gelatinization of the starch and 70% denaturation of the protein.

What is claimed is:

1. An apparatus for preparing food products consisting essentially of a conditioning element, a gear pump, and a die.

2. The apparatus of claim 1, further including a transfer device.

3. The apparatus of claim 2, wherein the transfer device is selected from the group consisting of a hopper, a feeder screw and a screw auger.

4. The apparatus of claim 1, wherein the gear pump is an internal rotary gear pump.

5. A method for preparing a food product comprising the steps of:
a. providing a food material comprising starch and/or protein;
b. cooking the food material using the apparatus of claim 1.

6. The method of claim 5, wherein the cooking step uses the apparatus of claim 2.

7. The method of claim 5, wherein the food material is cooked from about 80% to 100%.

8. The method of claim 5, where the starch is gelatinized from about 90% to 100%.

9. The method of claim 5, where the protein is denatured from about 70% to 100%.

10. The method of claim 5, wherein the conditioning element and gear pump are oriented at an angle of about 35°.

11. The method of claim 6, wherein the food material is cooked from about 80% to 100%.

12. The method of claim 6, where the starch is gelatinized from about 90% to 100%.

13. The method of claim 6, where the protein is denatured from about 70% to 100%.

14. A method for preparing a food product comprising the steps of:
a. introducing a food material comprising starch and/or protein to a conditioning element;
b. introducing the food material exiting the conditioning element to a gear pump; and
c. introducing the food material exiting the gear pump to a die.

15. The method of claim 14, wherein the food material is cooked as it is introduced to the conditioning element.

16. The method of claim 15, wherein the food material is cooked from about 80% to 100%.

17. The method of claim 16, wherein the cooking is gelatinization of starch and/or denaturing of protein.

18. The method of claim 17, wherein the cooking does not result from use of an extruder.

19. The method of claim 14, where an extruder is not utilized.

20. The method of claim 14, where the method results in a physical change of the food material.
